(19) United States
(12) Patent Application Publication
(10) Pub. No.: US 2015/0314759 A1
(43) Pub. Date: Nov. 5, 2015

(54) VEHICLE MOVEMENT DYNAMICS CONTROL METHOD

(71) Applicant: CONTINENTAL TEVES AG & CO. OHG, Frankfurt (DE)

(72) Inventors: Damien Nicolet, Frankfurt am Main (DE); Peter Balazs, Miskolc (HU)

(21) Appl. No.: 14/649,682

(22) PCT Filed: Nov. 27, 2013
(86) PCT No.: PCT/EP2013/074911

§ 371 Date: Jun. 4, 2015

(30) Foreign Application Priority Data
Dec. 6, 2012 (DE) 10 2012 222 489.0

(51) Int. Cl. B60T 8/1755

(52) U.S. Cl. CPC B60T 8/1755; B60T 2210/12; B60T 2270/313; B60T 2270/613; B60T 2270/86

(57) ABSTRACT

A method for controlling the movement dynamics of a motor vehicle, in which a measured transverse dynamics variable is compared with a transverse dynamics variable which is calculated on the basis of a vehicle model, wherein it is checked whether the vehicle is understeering, and in this case the difference between the measured and the calculated transverse dynamics variables is reduced by increasing braking forces at the wheels of at least the front axle independently of the driver. According to the invention, the time gradient of the braking force at each wheel at which a braking force is increased is selected in accordance with the difference between the measured and calculated transverse dynamics variables. In addition, the invention relates to a brake system for a motor vehicle.

### CROSS REFERENCE TO RELATED APPLICATIONS

This application is the U.S. National Phase application of PCT International Application No. PCT/EP2013/074911, filed Nov. 27, 2013, which claims priority to German Patent Application No. 10 2012 222 489.0, filed Dec. 6, 2012, the contents of such applications being incorporated by reference herein.

### FIELD OF THE INVENTION

The invention relates to a method for controlling the movement dynamics of a motor vehicle and to a braking system.

### BACKGROUND OF THE INVENTION

Many modern vehicles have a vehicle dynamics control system, in which the actual behavior is determined with the aid of a yaw rate sensor, wheel speed sensors and a transverse acceleration sensor, for example, and compared with a setpoint behavior calculated by means of the measured steering angle using a vehicle model. In a yawing moment control system, the measured actual yaw rate of the vehicle and the calculated setpoint yaw rate are compared; if the difference exceeds an activation threshold value and, if appropriate, other entry conditions are met, braking actions independent of the driver are performed at one or more wheels. If understeer is detected, where the setpoint yaw rate exceeds the actual yaw rate, the rear wheel on the inside of the bend is braked in order to bring the actual behavior closer to the setpoint behavior. This enables slight understeer to be corrected; however, the yawing moments which can be achieved are low.

A device for controlling the yawing moment of a four-wheel motor vehicle during cornering is known from EP 0 792 229 B1, which is incorporated by reference, for example. This device has a unit for detecting the current friction coefficient. When the vehicle is going round a bend and the yawing moment controller enters into control mode, a current friction coefficient is determined continuously, at least during yawing moment control. The current friction coefficient is calculated by means of the measured transverse acceleration and of a longitudinal acceleration of the vehicle, which is determined with the aid of wheel speed sensors, for example.

EP 0 945 320 B1, which is incorporated by reference, discloses a method for controlling vehicle dynamics in which vehicle understeer is corrected by a procedure in which a maximum transverse acceleration that the vehicle must not exceed for stability reasons is estimated, a longitudinal deceleration is calculated by means of the maximum transverse acceleration, and the speed of the vehicle is reduced in accordance with the calculated deceleration by means of braking actions at all the wheels and a reduction in the engine torque. On a low friction surface, there is the risk that driving stability will be lost through an excessive braking action at the rear axle.

EP 1 220 771 B1, which is incorporated by reference, discloses a vehicle-stabilizing device for setting or modifying brake pressures in the wheel brakes of a brake system, having an understeer detection system for determining an understeer driving state, a device for calculating a setpoint vehicle deceleration and, derived from the latter, a setpoint braking force or a setpoint brake pressure in accordance with the understeer driving state, and a yawing moment unit, which calculates a required yawing moment in accordance with a control error. The setpoint braking forces at the wheel brakes of the front axle are formed in accordance with the setpoint vehicle deceleration, wherein a differential braking force with respect to the front axle wheel on the inside of the bend is set at the front axle wheel on the outside of the bend to produce the required yawing moment and correct the understeer driving state. If appropriate, the remaining yawing moment required is applied at the rear wheel on the inside of the bend. By virtue of the fact that the braking actions take place at the front axle, there is no risk to driving stability. Because understeer control involves first of all determining a deceleration and then converting it into a pressure demand, the controller has a multiplicity of parameters, which have to be adapted to the respective vehicle type.

### SUMMARY OF THE INVENTION

An aspect of the present invention specifies a particularly simple method for controlling vehicle dynamics which controls or reduces vehicle understeer quickly and comfortably.

Thus, the invention provides a method for controlling the movement dynamics of a motor vehicle, in which a measured transverse dynamics variable is compared with a transverse dynamics variable which is calculated by means of a vehicle model, wherein it is checked whether the vehicle is understeering and, in this case, the difference between the measured and the calculated transverse dynamics variable is reduced by building up braking forces at least at the wheels of the front axle independently of the driver. According to the invention, the time gradient of the braking force at each wheel at which a braking force is built up is selected in accordance with the difference between the measured and the calculated transverse dynamics variable.

The vehicle dynamics control system according to the invention is based on the notion of selecting the additional pressure demand or gradient of the braking force buildup in accordance with the deviation between the calculated transverse dynamics variable and the measured transverse dynamics variable. It is thereby also possible to omit determination of a setpoint deceleration, i.e. the controller is structurally simpler. This has several advantages:
1. Since a pressure demand is calculated by means of a transverse dynamics variable that can be understood by the driver and the number of parameters is smaller, the adaptation, known as an application, of the controller to a new vehicle type can be performed quickly and simply.
2. Since the complexity of calculating a pressure demand or the braking force to be built up has been significantly reduced, the required computing power of a microcontroller suitable for carrying out the method is reduced in a corresponding fashion. Thus, it is also possible to use less expensive microcontrollers in a corresponding control unit.
3. By virtue of the fact that the braking torque buildup takes place quickly in the case of severe understeer, the available cornering potential of the tire is used in the optimum way.
4. If there is only a slight tendency for understeer, intervention can be gentler and hence more comfortable for the driver.

It is expedient if the transverse dynamics variable taken into account is the steering angle, i.e. the lock angle of the front wheels or the steering wheel angle, wherein, in particular, the calculated steering angle is determined by means of the single-track model at least from the yaw rate and vehicle speed. This choice of the transverse dynamics variable is advantageous particularly because the measured steering angle reproduces the driver's intention without delay, i.e. in contrast to control of the yaw rate, it is not the vehicle response (delayed by inertia) which is the first factor that can be measured. Steering by the driver has a direct effect on the control system and, as a result, the vehicle complies with the driver's intention more efficiently and control becomes more comfortable.

The braking force built up and/or the time gradient of the braking force built up at the front wheel on the outside of the bend is preferably less than that at the front wheel on the inside of the bend by in each case an asymmetry value. It is thus possible to introduce into the vehicle a yawing moment which further reduces understeer. In particular, the respective asymmetry value is selected in accordance with the vehicle speed and/or an estimated friction coefficient and/or the difference between the measured and the calculated transverse dynamics variable.

The invention furthermore relates to a braking system for a motor vehicle, comprising at least two sensors for measuring transverse dynamics variables, such as the yaw rate and/or transverse acceleration and/or steering angle, and a wheel speed sensor at each wheel of the vehicle, wherein at least the wheels of the front axle of the motor vehicle have wheel brakes, which enable braking forces to be built up independently of the driver at individual wheels, and an electronic control unit which carries out a method according to the invention.

### BRIEF DESCRIPTION OF THE DRAWINGS

Further preferred embodiments will become apparent from the dependent claims and the following description of an illustrative embodiment by means of figures, of which

FIG. 1 shows a schematic illustration of an illustrative motor vehicle, and

FIG. 2 shows an illustrative structure of a control system according to the invention.

### DETAILED DESCRIPTION OF THE PREFERRED EMBODIMENTS

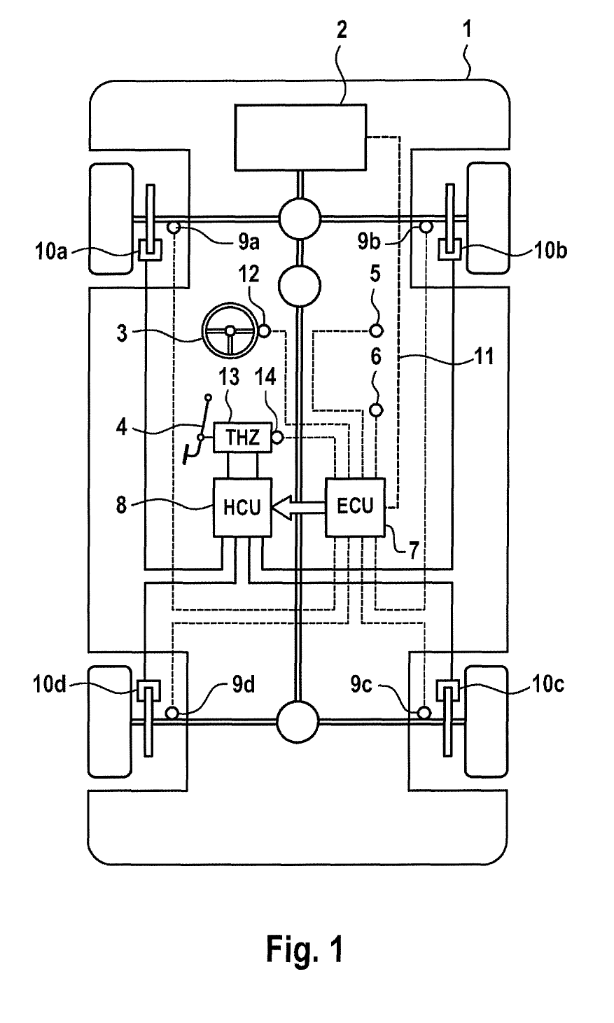

FIG. 1 shows a schematic illustration of an illustrative motor vehicle 1, which is suitable for carrying out the method according to the invention. It has an engine 2, which drives at least some of the wheels of the vehicle, a steering wheel 3, a brake pedal 4, which is connected to a tandem master cylinder (THZ) 13, and four individually controllable wheel brakes 10a-10d. The method according to an aspect of the invention can also be carried out if only some of the vehicle wheels are driven and/or conventional differentials are used. Apart from hydraulic friction brakes, it is also possible to use electromechanically actuated friction brakes as wheel brakes at one, several or all of the wheels. The vehicle can also have an electric drive, wherein, in particular, the braking torque at at least one wheel is produced at least in part by the electric machine/s operated as a generator.

To detect states pertaining to driving dynamics, a steering angle sensor 12, four wheel speed sensors 9a-9d, a transverse acceleration sensor 5, a yaw rate sensor 6 and at least one pressure sensor 14 for the brake pressure produced by the brake pedal are present. In this case, the pressure sensor 14 can also be replaced by a pedal-travel or pedal-force sensor if the auxiliary pressure source is arranged in such a way that a brake pressure built up by the driver cannot be distinguished from that of the auxiliary pressure source or an electromechanical brake actuator with a known correlation between the pedal position and the braking torque is used. The steering angle sensor can measure the steering wheel angle or other variables from which information relating to the trajectory desired by the driver can be determined.

The electronic control unit (ECU) 7 receives the data from the various sensors and controls the hydraulic unit (HCU) 8. In addition, the driving torque currently being produced by the engine 2 and the torque desired by the driver are determined. These can also be indirectly determined variables derived, for example, from an engine map and transmitted to the electronic control unit 7 via an interface 11 of a vehicle data bus, e.g. CAN, by the engine control unit (not shown).

The handling of the motor vehicle 1 is significantly affected by the design of the running gear, wherein the wheel load distribution, flexibility of the wheel suspensions and tire properties are among the factors determining the self-steering behavior. In certain driving situations, which are characterized by a stipulated desired bend radius and the friction coefficient between the tires and the roadway, there may be a loss of driving stability, wherein the steering behavior desired by the driver cannot be achieved with the given design of the running gear. By means of the available sensors, the driver's intention can be detected and its implementation by the vehicle can be checked.

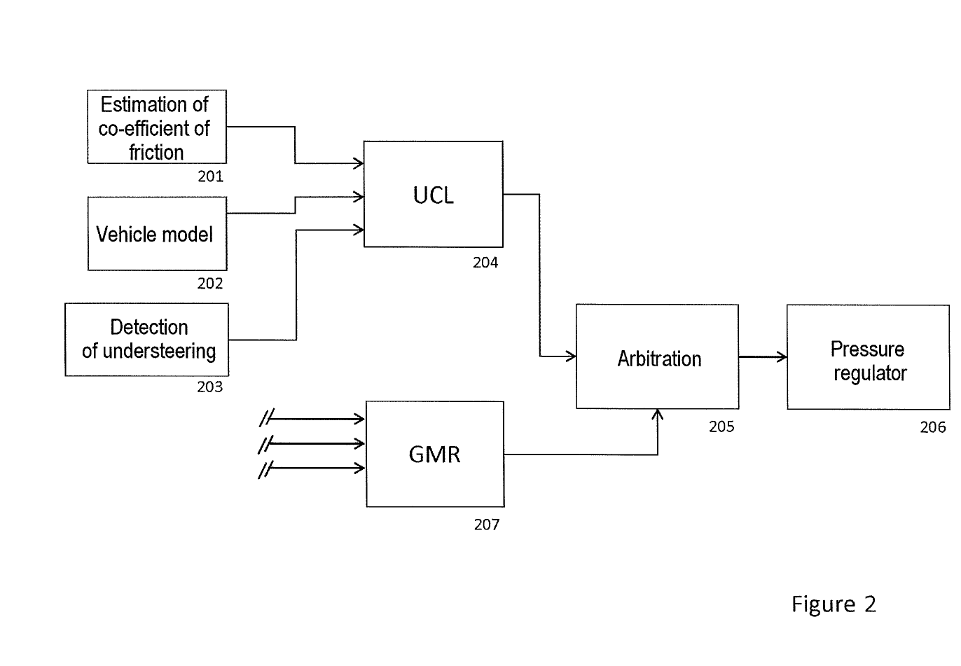

FIG. 2 shows an illustrative structure of a control system according to the invention, which can also be implemented entirely or partially as a program that can be executed by a microcontroller. In this structure, individual functional units or modules are shown as rectangles and arrows indicate the signal or information flow.

Module 201 is used to estimate the friction coefficient, wherein it is expedient if at least the transverse acceleration a_{Q} measured by means of sensor 5 and a longitudinal acceleration a_{L} measured or determined from wheel speed sensor signals are used as input variables. The instantaneously used friction coefficient μ indicates the minimum available friction coefficient and, for example, is calculated in accordance with the following relation (here, g denotes the acceleration due to gravity):

$$μ = \sqrt{{( \frac{{a}_{L}}{g} )}^{2} + {( \frac{{a}_{Q}}{g} )}^{2}} \qquad ( 1 )$$

Model 202 serves to describe the setpoint vehicle behavior, wherein at least the yaw rate \dot{ψ} measured by means of a yaw rate sensor 6, the vehicle speed V determined by means of wheel speed sensor signals, for example, and the friction coefficient μ estimated in module 201 are used as input variables. In a vehicle model, e.g. the known single-track model, the theoretical lock angle δₜₕₑₒ, which denotes the angle of the steered wheels of a vehicle to the longitudinal axis thereof, is calculated from the input variables, constant properties of the vehicle and, if appropriate, further variables. The lock angle δ and the steering wheel angle λ are related by δ=λ/K, wherein K indicates the steering ratio. There is therefore a direct correspondence between the steering wheel angle and the lock angle and they are also combined below in the term “steering angle”. The single-track model of a motor vehicle includes the wheels on one axle, and the relationship between the lock angle δₜₕₑₒ and the yaw rate \dot{ψ} can therefore be described as follows:

$${δ}_{theo} = \frac{\dot{ψ} \cdot l}{V} + EG \cdot \dot{ψ} \cdot V \qquad ( 2 )$$

Here, V denotes the current vehicle speed, while the wheelbase I and the self-steering gradient EG are vehicle parameters given by the design or measured in a driving test. Equation (2) applies only under certain driving conditions; the range of application of the vehicle model can be expanded by taking into account further terms.

Module 203 is used to detect whether there is vehicle understeer, wherein at least the calculated steering angle δₜₕₑₒ and the measured steering angle δₘₑₛₛ are used as input variables. In principle, understeer detection and/or control can also be accomplished by means of the other transverse dynamics variables measured by means of a sensor, such as transverse acceleration or yaw rate. However, consideration of the steering angle is advantageous with a view to a direct response to the driver's intention.

Understeer is expediently detected if the absolute value of the measured transverse dynamics variable is greater than the absolute value of the calculated transverse dynamics variable by more than an activation threshold value and the signs of the measured and the calculated transverse dynamics variable agree. Thus, as soon as the steering angle difference exceeds the activation threshold value, understeer control is activated. Accordingly, the buildup of braking torques independently of the driver is terminated when the difference between the measured transverse dynamics variable and the calculated transverse dynamics variable falls below a termination threshold value, which is, in particular, lower than the activation threshold value. Immediate reentry to understeer control is avoided by providing a hysteresis.

Further conditions are preferably checked for the activation and termination of control, it being possible, for example, for activation to take place only when the vehicle is moving forward at at least a predetermined speed. Activation can also remain off in the case of a very high yawing acceleration and/or dynamic, i.e. rapidly changing, steering by the driver.

Module 204 provides the actual understeer controller UCL, wherein the estimated friction coefficient μ, an activation signal output by the understeer detector, and the steering angle difference AA preferably being used as input variables. It is expedient if calculation of a braking force or pressure demand is repeated at regular time intervals tₗₒₒₚ, e.g. by repeatedly executing a program loop. The additional braking force or pressure demand

$$\frac{Δ p}{loop}$$

can then be determined in accordance with the following equation:

$$\frac{Δ p}{loop} = ( Δλ - ( ɛ - τ ) ) \cdot κ \qquad ( 3 )$$

Thus, the time gradient of the braking force or pressure buildup is dependent on the steering angle difference, i.e. the degree of understeer. In addition to the entry threshold E, a hysteresis τ between the entry and exit thresholds is taken into account (or the steering angle difference is corrected by the exit threshold). The control error is multiplied by a proportionality factor κ=f(μ) dependent on the estimated friction coefficient. It is expedient to describe the friction coefficient dependence by means of a characteristic curve, which has been determined by means of driving tests, for example. As a supplementary measure, provision can also be made to determine further additive components of braking force or pressure demands in accordance with the time change in the steering angle difference \dot{Δ}λ or a time integral over the steering angle difference.

The braking forces required by the understeer controller or corresponding setpoint pressures \hat{p}ᵢ are fed to module 205. Here, arbitration takes place between this pressure demand and the pressure demand \tilde{p}ᵢ of module 207, a yawing moment controller GMR known per se, and, if appropriate, further modules (not shown).

Arbitrator 205 uses predetermined criteria to select the braking force or pressure demand pᵢ to be implemented for each wheel and transmits these to pressure regulator 206. This expediently provides braking slip control and controls the brake actuators so as to build up a braking force. Here, the braking force and pressure demands are, in principle, equivalent and differ only in terms of a constant factor.

The brake pressure buildup in a hydraulic brake system having a tandem brake master cylinder is expediently performed by means of a changeover/block valve control system of the kind described in EP 1 177 121 B1, which is incorporated by reference.

The method according to the invention can also be carried out with a “brake-by-wire” braking system, in which the driver's braking demand and the braking force buildup are completely decoupled, as in the braking system disclosed in DE 10 2010 040 097 A1, which is incorporated by reference, for example.

The distribution of the braking forces between the wheels of the front axle, wherein therefore the wheel on the outside of the bend can be subject to less severe braking, and further optional features of the method according to the invention can be found in EP 1 220 771 B1, which is incorporated by reference.

By virtue of the fact that the time gradient of the braking force buildup is selected in accordance with the understeer quantified by means of a transverse dynamics variable, the vehicle response is always comfortable and subjectively understandable for the driver.

Since the measured steering angle is selected as a transverse dynamics variable, steering by the driver causes a stronger braking action without delay. Thus, a particularly direct response of the vehicle to the driver's intention can be ensured.

1. A method for controlling the movement dynamics of a motor vehicle, in which a measured transverse dynamics variable is compared with a transverse dynamics variable which is calculated by a vehicle model, wherein it is checked whether the vehicle is understeering and, in this case, the difference between the measured and the calculated transverse dynamics variable is reduced by building up braking forces at the wheels of at least the front axle independently of the driver, wherein the time gradient of the braking force at each wheel at which a braking force is built up is selected in accordance with the difference between the measured and the calculated transverse dynamics variable.

2. The method as claimed in claim 1, wherein understeer is detected if the absolute value of the measured transverse dynamics variable is greater than the absolute value of the calculated transverse dynamics variable by more than an activation threshold value and the signs of the measured and the calculated transverse dynamics variable agree, wherein the buildup of braking forces independently of the driver is terminated when the difference between the measured transverse dynamics variable and the calculated transverse dynamics variable falls below a termination threshold value, which is, in particular, lower than the activation threshold value.

3. The method as claimed claim 1, wherein the time gradient at least of a first part of the braking force built up at one wheel is selected in a manner proportional to the difference between the measured and the calculated transverse dynamics variable, wherein only the part of the difference between the measured and the calculated transverse dynamics variable which exceeds an offset value is taken into account.

4. The method as claimed in claim 3, wherein a proportionality factor of the braking force buildup is selected in accordance with an estimated friction coefficient by a characteristic curve.

5. The method as claimed in claim 3, wherein a second part of the braking force built up at one wheel is furthermore built up in accordance with the time derivative of the difference between the measured and the calculated transverse dynamics variable and/or a third part of the braking force built up at one wheel is built up in accordance with the time integral of the difference between the measured and the calculated transverse dynamics variable.

6. The method as claimed in claim 1, wherein the transverse dynamics variable is the steering angle, wherein the calculated steering angle is calculated by the single-track model at least from the yaw rate and vehicle speed.

7. The method as claimed in claim 1, wherein the braking force at each wheel or the sum of the braking forces at the wheels is limited to a maximum value in accordance with the estimated friction coefficient and/or with a maximum permissible slip.

8. The method as claimed in claim 1, wherein the braking force built up and/or the time gradient of the braking force built up at the front wheel on the outside of the bend is less than that at the front wheel on the inside of the bend by in each case an asymmetry value, wherein the respective asymmetry value is selected in accordance with the vehicle speed and/or an estimated friction coefficient and/or the difference between the measured and the calculated transverse dynamics variable.

9. A braking system for a motor vehicle, comprising at least two sensors for measuring transverse dynamics variables, such as the yaw rate and/or transverse acceleration and/or steering angle, and a wheel speed sensor at each wheel of the vehicle, wherein at least the wheels of the front axle of the motor vehicle have wheel brakes, which enable braking forces to be built up independently of the driver at individual wheels, wherein an electronic control unit which carries out a method for controlling movement dynamics of a motor vehicle, in which a measured transverse dynamics variable is compared with a transverse dynamics variable which is calculated by a vehicle model, wherein it is checked whether the vehicle is understeering and, in this case, the difference between the measured and the calculated transverse dynamics variable is reduced by building up braking forces at the wheels of at least the front axle independently of the driver, wherein the time gradient of the braking force at each wheel at which a braking force is built up is selected in accordance with the difference between the measured and the calculated transverse dynamics variable.

10. The braking system as claimed in claim 9, wherein the wheels at least of the front axle are connected to an electric motor, or are each connected to an electric motor, and in that the buildup of braking torque is accomplished at least in part by the electric motor or electric motors operated as generators.

11. The method as claimed claim 2, wherein the time gradient at least of a first part of the braking force built up at one wheel is selected in a manner proportional to the difference between the measured and the calculated transverse dynamics variable, wherein only the part of the difference between the measured and the calculated transverse dynamics variable which exceeds an offset value is taken into account.

12. The method as claimed in claim 4, wherein a second part of the braking force built up at one wheel is furthermore built up in accordance with the time derivative of the difference between the measured and the calculated transverse dynamics variable and/or a third part of the braking force built up at one wheel is built up in accordance with the time integral of the difference between the measured and the calculated transverse dynamics variable.

13. The method as claimed in claim 1, wherein the transverse dynamics variable is the lock angle of the front wheels or the steering wheel angle, wherein the calculated steering angle is calculated by the single-track model at least from the yaw rate and vehicle speed.
